(19) United States
(12) Patent Application Publication
(10) Pub. No.: US 2024/0133766 A1
(43) Pub. Date: Apr. 25, 2024

(54) MONITORING AND EARLY WARNING SYSTEM BASED ON INTERNET OF THINGS FOR ANCIENT BUILDING

(71) Applicant: China Jikan Research Institute of Engineering Investigations and Design, Co., Ltd., Xi'an (CN)

(72) Inventors: Junlian LI, Xi'an (CN); Huan LI, Xi'an (CN); Wei WANG, Xi'an (CN); Long WANG, Xi'an (CN); Ransheng CHEN, Xi'an (CN)

(73) Assignee: China Jikan Research Institute of Engineering Investigations and Design, Co., Ltd., Xi'an (CN)

(21) Appl. No.: 18/380,673

(22) Filed: Oct. 17, 2023

(30) Foreign Application Priority Data
Oct. 17, 2022 (CN) 202211267783.0

(51) Int. Cl. G01M 5/00; G01M 7/02; G06N 3/08

(52) U.S. Cl. CPC G01M 5/0033; G01M 7/025; G06N 3/08

(57) ABSTRACT

A monitoring and early warning system based on the Internet of Things for an ancient building includes an information acquisition system, a service platform and a user side. The information acquisition system is configured to acquire state data of the ancient building and upload the state data to the service platform by means of a 4G/5G gateway. The user side is integrated in a visualization device for a user to manage, analyze and interact with the acquired ancient building data, and the user side includes a monitoring module, a pre-alarm module, a management module and an expert module. The service platform is of a duster system integrating a plurality of applications, caches and database servers. The expert module is of a Res-long short-term memory (Res-LSTM) neural network model for evaluating a crack state of the ancient building.

### CROSS REFERENCE TO THE RELATED APPLICATIONS

This application is based upon and claims priority to Chinese Patent Application No. 202211267783.0, filed on Oct. 17, 2022, the entire contents of which are incorporated herein by reference.

### TECHNICAL FIELD

The present invention relates to the technical field of monitoring for cultural relics, and in particular to a monitoring and early warning system based on the Internet of Things for an ancient building.

### BACKGROUND

For health monitoring of an ancient building, a large number of sensors are usually additionally mounted on the ancient building, and data acquired by the sensors are statistically analyzed to determine whether a health state of the ancient building is good. The above method lags behind, and when the sensors acquire the data of the ancient building, the situations of data missing or inaccurate acquisition will occur, such that there is a certain difference between the finally analyzed health state of the ancient building and an actual state thereof. However, the prior art always lacks an effective prediction model to predict and evaluate the health state of the ancient building, such that management personnel fail to accurately know the true health state of the ancient building in real time. Based on this, the present invention provides a monitoring and early warning system based on the Internet of Things for an ancient building.

### SUMMARY

In order to solve the above technical problems existing in the prior art, the present invention provides a monitoring and early warning system based on the Internet of Things for an ancient building.

In order to achieve the above objective, the present invention provides the technical solutions as follows: the monitoring and early warning system based on the Internet of Things for an ancient building includes an information acquisition system, a service platform and a user side.

The information acquisition system is configured to acquire state data of the ancient building and upload the state data to the service platform by means of a 4G/5G gateway.

The user side is integrated in a visualization device for a user to manage, analyze and interact with the acquired ancient building data, and includes a monitoring module, a pre-alarm module, a management module and an expert module.

The service platform is of a cluster system integrating a plurality of applications, caches and database servers, and

the expert module is of a neural network model for evaluating a health state of the ancient building.

Preferably, the information acquisition system includes a vibration sensor and a crack sensor, and the neural network model is a Res-long short-term memory (Res-LSTM) neural network model for evaluating a crack state of the ancient building.

Preferably, the Res-LSTM neural network model includes an input layer, four LSTM blocks, a generic average pooling (GAP) layer and a softmax classifier, where the input layer is of multidimensional vibration data acquired by a plurality of acceleration sensors. Three of the four LSTM blocks have the same structure and each are composed of an LSTM unit, a batch normalization (BN) layer, a rectified linear unit (ReLU) layer and a Drodot layer, and ratios of the Drodot layer to the LSTM blocks are 0.2, 0.2 and 0.4 respectively. The other LSTM block is composed of an LSTM unit and a BN layer, and the four LSTM blocks jointly form a residual structure.

Preferably, when the Res-LSTM neural network model is trained, a ReLU is used as an activation function, and a formula thereof is: f(x)=max(0, x).

Preferably, in a training process of the Res-LSTM neural network model, a classification cross entropy is used as a loss function of the neural network model, and a calculation formula thereof is

$$L ( {y}^{⌣} , y ) = - \frac{1}{n} {\sum }_{i = 1}^{n} {\sum }_{j = 1}^{k} {y}_{i} log {{y}^{⌣}}_{i}$$

In the formula, yᵢ and \check{y}ᵢ are real output and predicted output respectively, and n and k are the total number of training samples and the number of classes respectively.

Preferably, the information acquisition system further includes a camera, an acceleration sensor, a tilt sensor, a temperature and humidity sensor, a displacement sensor and a wind speed and direction sensor.

Preferably, the management module includes three portions, namely ancient building information management, information acquisition system management and data pre-alarm management, where the ancient building information management is used for adding or modifying basic information of the ancient building, the information acquisition system management is used for adding or modifying information of the information acquisition system, and the data pre-alarm management is used for counting all pre-alarm data of the information acquisition system, including time and a frequency.

Preferably, the process in which the crack state of the ancient building is evaluated by using the Res-LSTM neural network model is as follows:

S1, data query: querying original monitoring data of the crack sensor from the service platform by a user;

S2, data preprocessing: performing abnormal data elimination, missing data complementation and data smoothing processing on the original monitoring data obtained in step S1 in sequence to obtain a data set; and

S3, neural network model evaluation: inputting the data set obtained in step S2 into the neural network model to obtain a final evaluation value.

Preferably, the expert module uses an independent server to run background services thereof.

Compared with the prior art, the present invention provides the monitoring and early warning system based on the Internet of Things for an ancient building, which has the following beneficial effects:

According to the present invention, different kinds of sensors are additionally mounted on the ancient building, such that the ancient building can be comprehensively monitored. Moreover, the expert module is designed on an existing service platform, and the expert module is of the Res-LSTM neural network model for evaluating the crack state of the ancient building. The crack information of the ancient building is acquired by the crack sensor, and then, the data is input into the Res-LSTM neural network model after abnormal data elimination, missing data complementation and data smoothing processing, such that a crack evaluation prediction of an ancient building model can be obtained, a prediction of the state of the ancient building can be achieved, and management personnel can be timely reminded to take measures in advance so as to facilitate health management of the ancient building.

### BRIEF DESCRIPTION OF THE DRAWINGS

The accompanying drawings, which are used for providing further understanding of the present invention and constitute part of the description, together with the examples of the present invention, serve to explain the present invention instead of limiting the present invention. In the figures:

FIG. 1 is a schematic diagram of a monitoring and early warning system based on the Internet of Things for an ancient building in an example;

FIG. 2 is a schematic structural diagram of a Res-LSTM neural network model in an example;

FIG. 3 is a schematic diagram of an integral structure of a camera in an example;

FIG. 4 is a schematic diagram of a box door in an open state in FIG. 3;

FIG. 5 is a schematic diagram of a back structure of a camera in an example;

FIG. 6 is a schematic diagram of an internal structure of a water tank assembled on a mounting base in an example;

FIG. 7 is a schematic structural diagram of a scrubbing plate assembled on a moving frame in an example;

FIG. 8 is a schematic structural diagram of an interior of a fixing frame from a cutaway view in an example;

FIG. 9 is a partially enlarged schematic structural diagram of portion A in FIG. 8;

FIG. 10 is a schematic diagram of a mounting plate from a three-dimensional sectional view in an example;

FIG. 11 is a partially enlarged schematic structural diagram of portion B in FIG. 10;

FIG. 12 is a schematic diagram for assembly of a first bevel gear, a second bevel gear and a spur cylindrical gear on a fixing frame in an example; and

FIG. 13 is a schematic diagram of a water tank from a three-dimensional sectional view in an example.

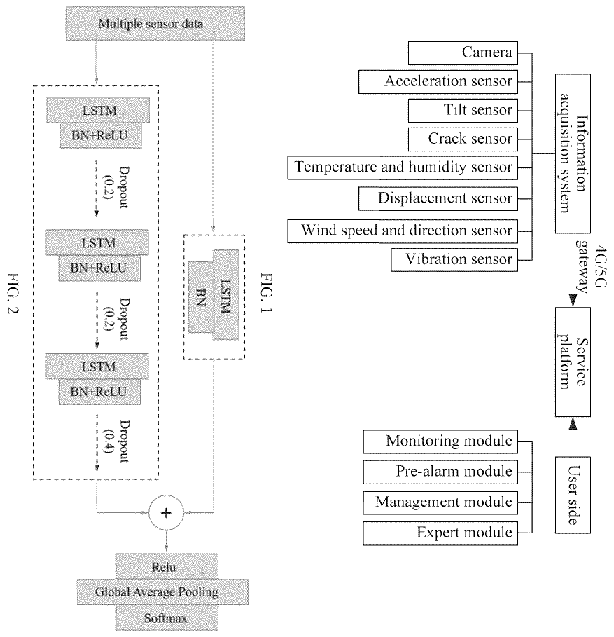

In the figures: 1, mounting base; 2, protective box; 3, fixing frame; 4, water tank; 5, booster pump; 6, spray pipe; 7, liquid injection pipe; 8, moving frame; 9, scrubbing plate; 10, supporting rod; 11, box door; 12, camera; 13, second threaded rod; 14, T-shaped sliding block; 15, first threaded sleeve; 16, first threaded rod; 17, sliding rail; 18, vent hole; 19, guide post; 20, limiting sleeve; 21, insertion plate; 22, second threaded sleeve; 23, first spur gear; 24, spur cylindrical gear; 25, connecting block; 26, connecting rod; 27, stop bar; 28, cam; 29, first chain; 30, electric motor; 31, first shaft rod; 32, first bevel gear; 33, second bevel gear; 34, mounting support; 35, second shaft rod; 36, second chain; 37, flexible stop bar; and 38, right angle fixing plate.

### DETAILED DESCRIPTION OF THE EMBODIMENTS

The technical solutions in the examples of the present invention will be clearly and completely described below with reference to the accompanying drawings in the examples of the present invention. Obviously, the described examples are merely some examples rather than all examples of the present invention. Generally, assemblies of the examples of the present invention described and shown in the accompanying drawings may be arranged and designed in various manners. Therefore, the following detailed description of the examples of the present invention provided in the accompanying drawings is not intended to limit the scope of the present invention for which protection is claimed, but is merely representative of selected examples of the present invention. All other examples obtained by those of ordinary skill in the art based on the examples of the present invention without making creative efforts shall fall within the scope of protection of the present invention.

This example provides a monitoring and early warning system based on the Internet of Things for an ancient building, and the system includes an information acquisition system, a service platform and a user side.

The information acquisition system is configured to acquire state data of the ancient building and upload the state data to the service platform by means of a 4G/5G gateway. The information acquisition system includes a camera, an acceleration sensor, a tilt sensor, a crack sensor, a temperature and humidity sensor, a displacement sensor, a wind speed and direction sensor and a vibration sensor.

The acceleration sensor acquisition instrument is of a high-precision acceleration sensor with X, Y and Z axes, which has a 32-bit high-performance and low-power floating point processor, belonging to STM32L4 series MCU. A wireless LoRa module is integrated, which may be used for wireless transmission over a range of several kilometers and is equipped with a large-capacity battery for vibration monitoring of the ancient building. The crack sensor acquisition instrument is of a crack sensor matching Miran high-precision displacement sensor KTM series, which may be used for monitoring a crack state of the ancient buildings for a long time.

The user side is integrated in a visualization device for a user to manage, analyze and interact with the acquired ancient building data, and includes a monitoring module, a pre-alarm module, a management module and an expert module.

The monitoring module is configured to monitor the uploaded data in real time, in order to ensure security of data uploading, a public key of an RSA encryption algorithm is used for encryption in a data uploading process, and after the service platform receives the encrypted data, a private key of the RSA algorithm is used for decryption and identity verification, so as to ensure rationality of the data.

The pre-alarm module will pre-store a pre-alarm two-level threshold of each sensor. After the data is uploaded, the data will be compared with the corresponding threshold. If there is an alarm, an email and a short message will be sent to a person in charge to remind the person in charge of the occurrence of an abnormal condition. At the same time, the pre-alarm data will be stored in the service platform.

The management module includes three portions, namely ancient building information management, information acquisition system management and data pre-alarm management, where the ancient building information management is used for adding or modifying basic information of the ancient building, the information acquisition system management is used for adding or modifying information of the information acquisition system, and the data pre-alarm management is used for counting all pre-alarm data of the information acquisition system, including time and a frequency.

The service platform is the core portion of the whole system, and is an important guarantee for the reliable and stable operation of the whole system. In order to deal with storage and analysis of massive data, a cluster system integrating a plurality of applications, caches and database servers is built on the service platform. The database server is mainly configured to store the monitoring data of the ancient building and provide external data reading and writing services. The cache server allocates some data operations and mathematical calculations, and greatly relieves reading and writing pressure of a database. The application server is mainly configured to receive network requests and read and write database data from the user side, use these data to perform real-time processing, query, analysis, machine learning and other operations, achieve an evaluation of the state of the ancient building, and finally send these results to the user side by means of the Internet.

It should be noted that when monitoring and early warning are performed on the ancient building in the present application, the state data of the ancient building will be acquired by means of the information acquisition system and uploaded to the service platform by means of the 4G/5G gateway. Then, the application server in the service platform will process and analyze the above data and send the finally obtained result to the management personnel. The management personnel only compare the data detected by each sensor with the standard threshold. Only when the detected data exceeds the standard threshold, can the personnel know that the ancient building is in an unhealthy state. However, the management personnel cannot predict a health trend or damage degree of the ancient building based on existing acquired information. In view of this, in the present application, the expert module is set at the user side, and the expert module mainly performs machine learning analysis by means of a neural network model, so as to achieve the evaluation of the health state of the ancient building. In addition, the expert module in the present application uses an independent server to run background services thereof, such that the calculation pressure of the main server of the service platform can be relieved, the function of isolation can be played, the operation of the expert module and the operation of other modules are not influenced each other, and maintainability and expandability of the service platform are also improved.

Specifically, the expert module is of a Res-long short-term memory (Res-LSTM) neural network model for evaluating the health state of the ancient building.

As shown in FIG. 2, the Res-LSTM neural network model includes an input layer, four LSTM blocks, a GAP layer and a softmax classifier, where the input layer is of multidimensional vibration data acquired by a plurality of acceleration sensors, and a data structure of the input layer is three-dimensional. The first dimension represents the number of data samples, the second dimension represents the step size of the data, and the third dimension represents the number of features. Three of the four LSTM blocks have the same structure and each are composed of LSTM units (128, 256 and 256 channels respectively), a batch normalization (BN) layer, a rectified linear unit (ReLU) layer and a Drodot layer, where the Dropot layer reduces the risk of overfitting by suppressing the number of neurons activated in the neural network, and ratios of the Dropot layer in the LSTM blocks are 0.2, 0.2, and 0.4 respectively. The other LSTM block is composed of an LSTM unit (256 channels) and a BN layer, and the four LSTM blocks jointly form a residual structure to reduce influence of gradient vanishing. The GAP layer reduces the number of parameters of the neural network and improves a convergence speed of training. Finally, the softmax classifier is used for classifying the structure to get a result of crack damage recognition of the ancient building.

When the Res-LSTM neural network model is trained, the situation of gradient vanishing is likely to occur. Since the present application uses a ReLU as an activation function, the activation function is fast in calculation speed, and a calculation gradient is not too small. A formula thereof is: f(x)=max(0, x).

In addition, in a training process of the Res-LSTM neural network model, a classification cross entropy is used as a loss function of the neural network model, and a calculation formula is

$$L ( {y}^{⌣} , y ) = - \frac{1}{n} {\sum }_{i = 1}^{n} {\sum }_{j = 1}^{k} {y}_{i} log {{y}^{⌣}}_{i}$$

In the formula, yᵢ and \check{y}ᵢ are real output and predicted output respectively, and n and k are the total number of training samples and the number of classes respectively.

A specific method for evaluating the crack state of the ancient building by using the above-mentioned Res-LSTM neural network model is as follows:

Data query: a user queries original monitoring data of the crack sensor from the service platform.

Data preprocessing: the crack sensor is likely to be affected by noise when acquiring data, which leads to an obvious difference between a certain piece of data or some data in the original data and a true value, and therefore, abnormal data need to be eliminated. In the present application, the Pauta criterion is employed to monitor the abnormal situation of the data. Certainly, the sensor does not acquire data according to time, or the acquired data is lost when uploaded. Aiming at this phenomenon, the present application employs a mathematical interpolation method to insert virtual data into the original data to restore the original data. Moreover, noise data will inevitably be mixed in the process of monitoring data acquisition, existence of the noise data is a random error for the original data, which will have a greater impact on the quality of the data, and therefore, before data analysis, the data needs to be smoothed, that is, noise interference is removed, thereby improving a signal-to-noise ratio of the data, and processing a long-term evolution law of the data more obviously. In the present application, a regression method is employed for smoothing the acquired data.

Neural network model evaluation: the above data set obtained after preprocessing is normalized and then is input into the Res-LSTM neural network model to obtain a final evaluation value.

In this example, seven training data sets, being composed of vibration data acquired by the vibration sensor, of the Res-LSTM neural network model are set in total, and there are 7×48000, namely 336000 pieces of data in total. Then, the Res-LSTM neural network model is trained by using the training data set, and then crack lengths of the ancient building are selected to be 0 mm, 30 mm, 50 mm, 100 mm, 150 mm and 250 mm for recognition, and damage categories corresponding to the above cracks are 0, 1, 2, 3, 4 and 5 respectively. After an experiment, the recognition accuracy of the Res-LSTM neural network model on the crack can reach 95.8%, which is at least 3% higher than that of a traditional neural network model.

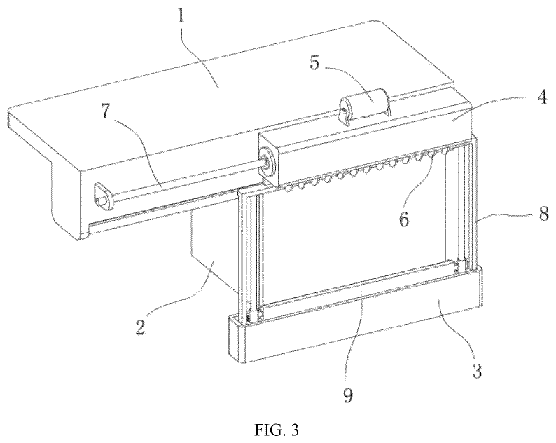

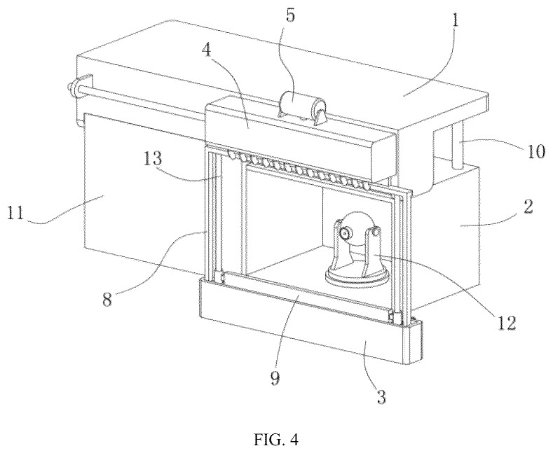

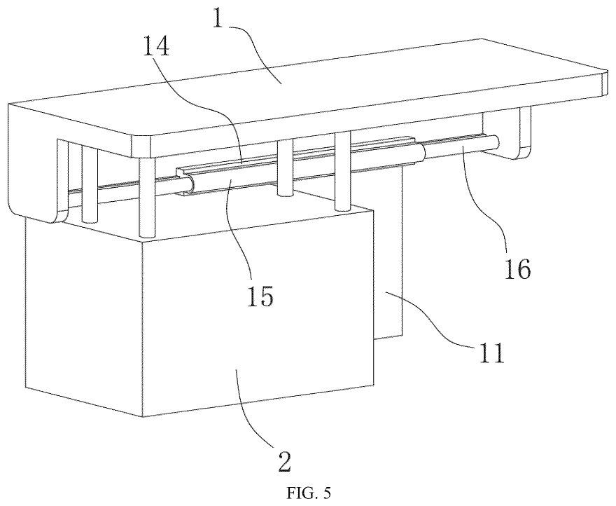

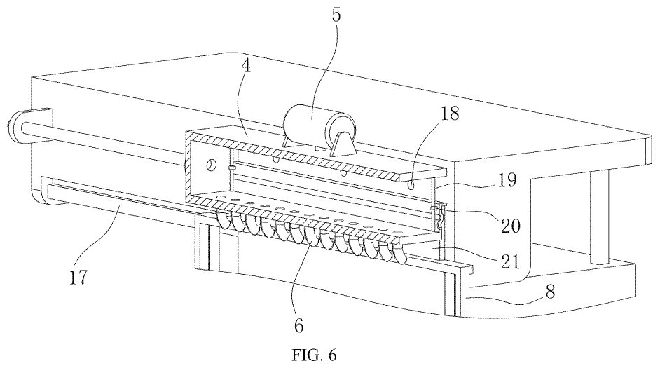

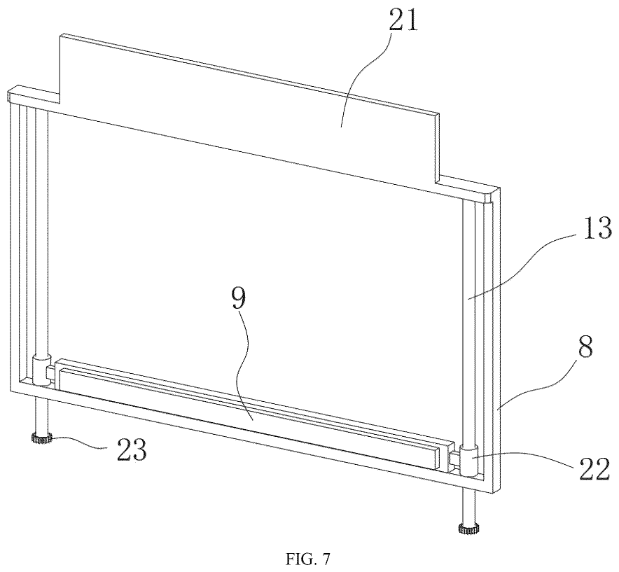

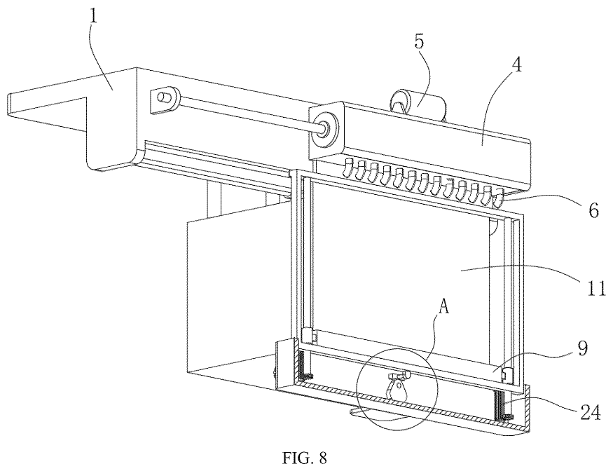

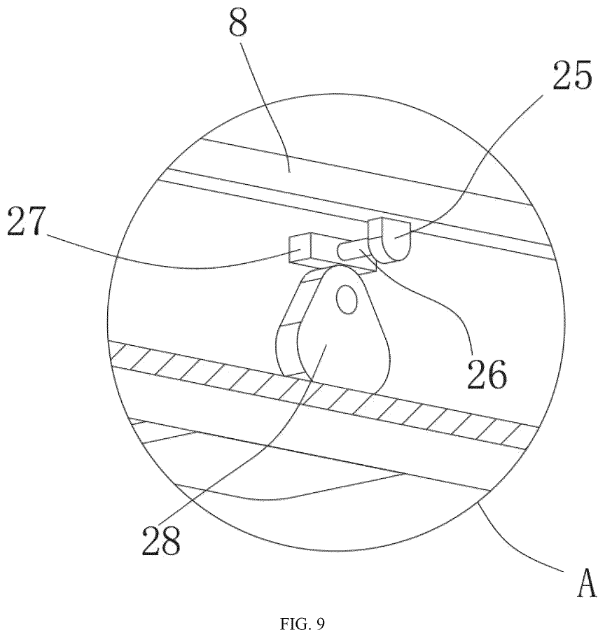

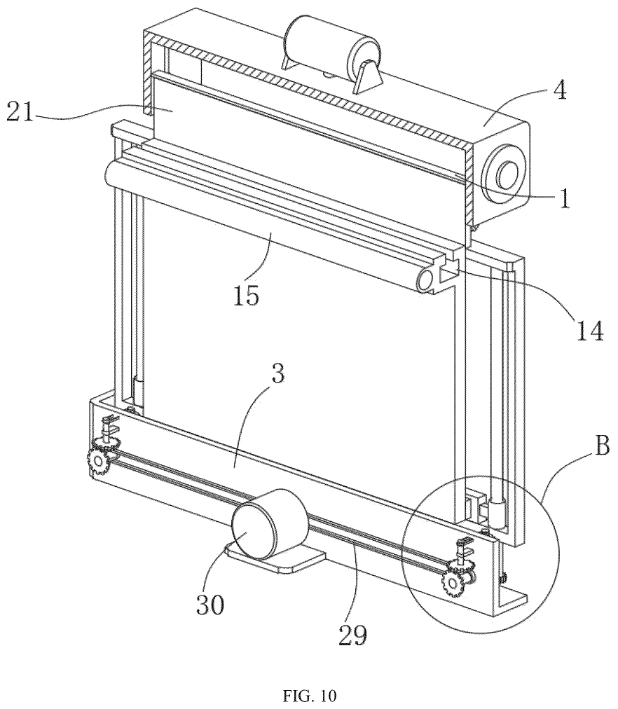

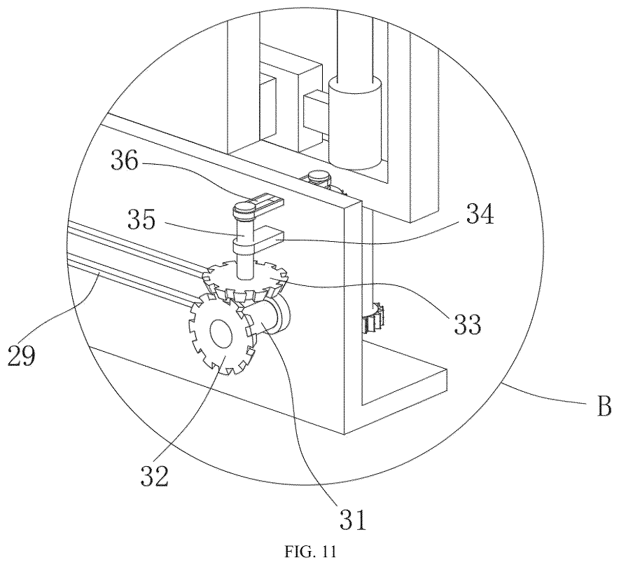

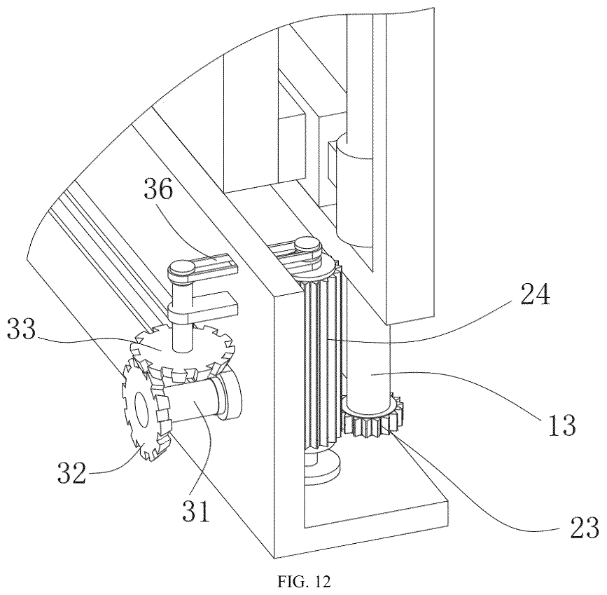

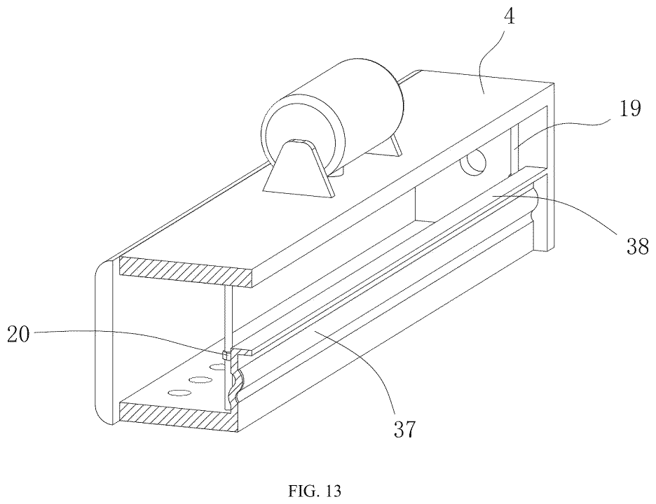

In addition, the present invention further provides a particular example of the camera 12 in the information acquisition system. As shown in FIGS. 3-13, the camera is hermetically arranged in a protective box 2, and the protective box 2 may play a certain protective role on the camera, thereby avoiding the situation that dust falls on a camera mirror surface of the camera 12, and consequently, an information acquisition effect is affected. A top of the protective box 2 is connected to a mounting base 1 by means of four supporting rods 10, and the mounting base 1 is provided with a sliding rail 17 in a lengthwise direction of the mounting base towards an opening side of the protective box 2. An opening of a front end of the protective box 2 is provided with a box door 11, a T-shaped sliding block 14 matching the sliding rail 17 is integrally formed at a top of the box door 11, and the box door 11 is embedded into the sliding rail 17 by means of the T-shaped sliding block 14 at the top of the box door to form a sliding guide assembly structure with the protective box 2. When the camera 12 inside the protective box 2 needs to be inspected, the box door 11 may be opened by means of sliding.

A first threaded sleeve 15 is arranged on one side of the T-shaped sliding block 14 in parallel in a lengthwise direction thereof, a first threaded rod 16 is rotationally mounted at the position, corresponding to the first threaded sleeve 15, of an interior of the mounting base 1, and the first threaded sleeve 15 is arranged on the first threaded rod 16 in a sleeving manner and is in threaded connection to the first threaded rod. The first threaded rod 16 is driven to rotate by an external power device such as an electric motor so as to drive the box door 11 to slide on the sliding rail 17, thereby achieving opening and closing of the box door 11.

Dust may be gathered on an outer surface of the box door 11 after a long time of work, so it is necessary to clean the surface of the box door regularly to prevent the dust on the box door 11 from affecting acquisition of the ancient building information. In order to avoid the above situation, in the present application, a moving frame 8 is arranged at a front end of the box door 11, and second threaded rods 13 are rotationally mounted at the positions, close to borders, of an inner side of the moving frame 8 in a vertical direction. A scrubbing plate 9 matching a length of the box door 11 is further arranged at the inner side of the moving frame 8, two ends of the scrubbing plate 9 are fixedly connected to second threaded sleeves 22 respectively, and the second threaded sleeves 22 are screwed on the corresponding second threaded rods 13. The scrubbing plate 9 is driven to move in the vertical direction by means of rotation of the two second threaded rods 13, thereby completing a scrubbing operation on the surface of the box door 11.

Furthermore, in order to improve the cleanliness of the surface cleaning of the box door 11, in the present application, a water tank 4 is fixedly mounted at a front end of the mounting base 1. The water tank 4 is arranged in a lengthwise direction of the mounting base 1, a water inlet of the water tank 4 is provided in an inner side of the water tank, and a liquid injection pipe 7 connected to the water inlet of the water tank 4 is connected to an external water supply system. The water inlet of the water tank 4 is also provided with a one-way valve to prevent water in the water tank 4 from flowing backward into the liquid injection pipe 7. A water level sensor is mounted inside the water tank 4, when the sensor detects that a water level in the water tank 4 is insufficient, the external water supply system can be driven to operate to supply water to an interior of the water tank 4, and when the water level in the water tank 4 reaches a certain height, the external water supply system stops operating. A booster pump 5 in communication with the interior of the water tank is mounted at a top of the water tank 4, and a row of spray pipes 6 are distributed at a bottom of the water tank 4. A pressure valve is mounted inside each spray pipe 6, that is, when the booster pump 5 works and injects a certain pressure into the interior of the water tank 4, and when a pressure value exceeds pressure valves inside the spray pipes 6, the spray pipes 6 are in a conducting state. The water in the water tank 4 is sprayed to the surface of the box door 11 by means of the row of spray pipes 6. Then, the scrubbing plate 9 slides on the surface of the box door 11 to clear the dust on the surface of the box door 11.

In order to enable the scrubbing plate 9 to slide on the surface of the box door 11, the water in the water tank 4 is sprayed to the surface of the box door 11 by means of the spray pipes 6. In the present application, a fixing frame 3 is integrally formed at a bottom of the protective box 2, an electric motor 30 is fixed at the back of the fixing frame 3, and an electric motor shaft of the electric motor 30 passes through the fixing frame 3 and extends to an interior of the fixing frame, and then is connected to a cam 28. A connecting block 25 at a bottom of the moving frame 8 is connected to a stop bar 27 matching the cam 28 by means of a connecting rod 26. A top of the moving frame 8 is fixedly connected to an insertion plate 21, when the electric motor 30 drives the cam 28 to rotate, the moving frame 8 may be driven to move in the vertical direction, and the insertion plate 21 may be inserted into the water tank 4 to form a sealed space inside the water tank.

Specifically, the side, close to the mounting base 1, of an interior of the booster pump 5 is connected to a flexible stop bar 37, and a right angle fixing plate 38 is integrally formed at a top of the flexible stop bar 37. A gap is reserved between the flexible stop bar and the right angle fixing plate, and the mounting base 1 after the flexible stop bar 37 and the right angle fixing plate 38 form an integral component, and the gap allows the insertion plate 21 to be inserted thereinto. The side, facing a cavity of the booster pump 5, of the right angle fixing plate 38 is fixedly connected to two limiting sleeves 20, two guide posts 19 are fixedly connected to the interior of the water tank 4 in the vertical direction, and the limiting sleeves 20 are slidably arranged on the corresponding guide posts 19 in a sleeving manner. In an initial state, a cavity of the water tank 4 is kept in communication with an outside by means of three vent holes 18 provided in the mounting base 1. Certainly, heights of the three vent holes 18 should exceed the position of the liquid level sensor so as to prevent the water in the water tank 4 from flowing into the outside by means of the vent holes 18. When the electric motor 30 drives the cam 28 to rotate from the position shown in FIG. 7, the moving frame 8 gradually rises in the vertical direction, and the insertion plate 21 is inserted into the water tank 4 to drive the right angle fixing plate 38 to move upwards along the guide post 19. When the cam 28 rotates to the position where a large-diameter end of the cam makes contact with the stop bar 27, the right angle fixing plate 38 is completely unfolded, and the flexible stop bar 37 rises to tightly fit with a top of the interior of the water tank 4, such that the water tank 4 is isolated from the outside. Since the large-diameter end of the cam 28 has an arc-shaped structure, the flexible stop bar 37 remains stationary during the contact process between the large-diameter end of the cam 28 and the stop bar 27, and the booster pump 5 at the top of the water tank 4 operates to inject pressure into the water tank, such that the water in the water tank 4 is sprayed to the surface of the box door 11. When the large-diameter end of the cam 28 is disengaged from the stop bar 27, the moving frame 8 starts to move downwards in the vertical direction. In this case, the insertion plate 21 is withdrawn from the water tank 4, and finally the water tank 4 is kept in a communication state with the outside by means of the vent holes 18 again. In this state, even if the booster pump 5 works, the water in the water tank 4 will not be sprayed out, and the cam 28 keeps rotating, such that the water in the water tank 4 is periodically sprayed onto the box door 11.

Since during rotation of the cam 28, the entire moving frame 8 has a limited range of motion in the vertical direction, and the scrubbing plate 9 mounted on the moving frame 8 has a limited range of motion. In order to enable the scrubbing plate 9 to slide relative to the moving frame 8, the bottoms of the two second threaded rods 13 on the moving frame 8 penetrate downwards through the moving frame 8 and are fixedly connected to a first spur gear 23 in a sleeving manner in the present application. A spur cylindrical gear 24 meshed with the first spur gear 23 is rotationally mounted inside the fixing frame 3 in the vertical direction, and the first spur gear 23 may also slide relative to the spur cylindrical gear 24 when the moving frame 8 moves in the vertical direction. A first chain wheel is fixedly connected at a top of the spur cylindrical gear 24 in a sleeving manner, and a second shaft, rod 35 is arranged on a side wall of the back of the fixing frame 3 in the vertical direction. The second shaft rod 35 is rotationally connected to a mounting support 34 fixed on the fixing frame 3, a second bevel gear 33 is connected to a bottom of the second shaft rod 35, a second chain wheel is arranged at a top of the second shaft rod in a sleeving manner, a second chain 36 is arranged between the first chain wheel and the second chain wheel in a sleeving manner, and a third chain wheel is further arranged on the electric motor shaft of the electric motor 30 in a sleeving manner. A first bevel gear 32 meshed with the second bevel gear is arranged below the second bevel gear 33, a first shaft rod 31 of the first bevel gear 32 extends axially and is rotationally connected onto the fixing frame 3, a fourth chain wheel is fixedly arranged on the first shaft rod 31 in a sleeving manner, and a first chain 29 is arranged between the fourth chain wheel and the third chain wheel in a sleeving manner. When the electric motor 30 drives the cam 28 to rotate, the fourth chain wheel on the electric motor shaft drives the first shaft rod 31 to rotate by means of the first chain 29. When the first bevel gear 32 rotates, the second bevel gear 33 engaged with the first bevel gear is driven to rotate. When the second bevel gear 33 rotates, the spur cylindrical gear 24 is driven to rotate by means of the second chain 36. The spur cylindrical gear 24 is meshed with the first spur gear 23 to drive the first spur gear 23 to rotate. The second threaded rod 13 in a rotating state can drive the scrubbing plate 9 to slide on the moving frame 8.

In the description of the present invention, the terms “first”, “second”, “the other” and “another” are for descriptive purposes only and are not to be construed as indicating or implying their relative importance or implicitly specifying the number of indicated technical features. Thus, a feature defined with “first” and “second” may explicitly or implicitly include one or more of the features. In the description of the embodiments of the present invention, “plurality” means two or more, unless expressly specified otherwise.

In the description of the present invention, it should be noted that, unless otherwise explicitly specified and defined, the terms “connecting” and “connection” should be understood in a broad sense, for example, they may be a fixed connection, a detachable connection, or an integrated connection; may be a mechanical connection, or an electrical connection; and may be a direct connection, or an indirect connection via an intermediate medium. For those of ordinary skill in the art, the specific meanings of the above terms in the present invention may be understood according to specific circumstances. In addition, in the description of the present invention, “plurality of” means two or more, unless otherwise specified.

Although the examples of the present invention have been illustrated and described, it should be understood that those of ordinary skill in the art may make various changes, modifications, replacements and variations to the above examples without departing from the principle and spirit of the present invention, and the scope of the present invention is limited by the claims and their legal equivalents.

What is claimed is:

1. A monitoring and early warning system based on Internet of Things for an ancient building, comprising an information acquisition system, a service platform and a user side, wherein
the information acquisition system is configured to acquire state data of the ancient building and upload the state data to the service platform by a 4G/5G gateway;
the user side is integrated in a visualization device for a user to manage, analyze and interact with acquired ancient building data, and the user side comprises a monitoring module, a pre-alarm module, a management module and an expert module;
the service platform is of a cluster system integrating a plurality of applications, caches and database servers; and
the expert module is of a neural network model for evaluating a health state of the ancient building.

2. The monitoring and early warning system based on the Internet of Things for the ancient building according to claim 1, wherein the information acquisition system comprises a vibration sensor and a crack sensor, and the neural network model is a Res-long short-term memory (Res-LSTM) neural network model for evaluating a crack state of the ancient building.

3. The monitoring and early warning system based on the Internet of Things for the ancient building according to claim 2, wherein the Res-LSTM neural network model comprises an input layer, a first LSTM block, a second LSTM block, a third LSTM block, a fourth LSTM block, a generic average pooling (GAP) layer and a softmax classifier, wherein the input layer is of multidimensional vibration data acquired by a plurality of acceleration sensors; the first LSTM block, the second LSTM block and the third LSTM have a same structure and each comprise an LSTM unit, a batch normalization (BN) layer, a rectified linear unit (ReLU) layer and a Drodot layer, and ratios of the Drodot layer to the first LSTM block, the second LSTM block and the third LSTM are 0.2, 0.2 and 0.4 respectively; and the fourth LSTM block comprises of an LSTM unit and a BN layer, and the first LSTM block, the second LSTM block, the third LSTM block and the fourth LSTM block jointly form a residual structure.

4. The monitoring and early warning system based on the Internet of Things for the ancient building according to claim 3, wherein when the Res-LSTM neural network model is trained, a ReLU is used as an activation function, and a formula of the activation function is: f(x)=max(0, x).

5. The monitoring and early warning system based on the Internet of Things for the ancient building according to claim 4, wherein in a training process of the Res-LSTM neural network model, a classification cross entropy is used as a loss function of the Res-LSTM neural network model, and a calculation formula of the loss function is
$$L ( {y}^{⌣} , y ) = - \frac{1}{n} {\sum }_{i = 1}^{n} {\sum }_{j = 1}^{k} {y}_{i} log {{y}^{⌣}}_{i} ,$$
wherein yᵢ and \check{y}ᵢ are a real output and a predicted output respectively, and n and k are a total number of training samples and a number of classes respectively.

6. The monitoring and early warning system based on the Internet of Things for the ancient building according to claim 1, wherein the information acquisition system further comprises a camera, an acceleration sensor, a tilt sensor, a temperature and humidity sensor, a displacement sensor, and a wind speed and direction sensor.

7. The monitoring and early warning system based on the Internet of Things for the ancient building according to claim 1, wherein the management module comprises an ancient building information management portion, an information acquisition system management portion and a data pre-alarm management portion, wherein the ancient building information management portion is used for adding or modifying basic information of the ancient building, the information acquisition system management portion is used for adding or modifying information of the information acquisition system, and the data pre-alarm management portion is used for counting all pre-alarm data of the information acquisition system, wherein the pre-alarm data comprises time and a frequency.

8. The monitoring and early warning system based on the Internet of Things for the ancient building according to claim 5, wherein the crack state of the ancient building is evaluated by using the Res-LSTM neural network model through steps of:
S1, data query: querying original monitoring data of the crack sensor from the service platform by a user;
S2, data preprocessing: performing abnormal data elimination, missing data complementation and data smoothing processing on the original monitoring data obtained in step S1 in sequence to obtain a data set; and
S3, neural network model evaluation: inputting the data set obtained in step S2 into the Res-LSTM neural network model to obtain a final evaluation value.

9. The monitoring and early warning system based on the Internet of Things for the ancient building according to claim 1, wherein the expert module uses an independent server to run background services of the expert module.
